(19) United States
(12) Patent Application Publication
(10) Pub. No.: US 2008/0002846 A1
(43) Pub. Date: Jan. 3, 2008

(54) HEARING PROTECTION AUDIO PROCESSING SYSTEM AND METHOD

(75) Inventors: SHIH-FANG WONG, Tu-Cheng (TW); YI-FENG WENG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/765,456

(22) Filed: Jun. 20, 2007

(30) Foreign Application Priority Data
Jun. 23, 2006 (CN) 200610061313.3

(51) Int. Cl. H04R 25/00

(52) U.S. Cl. 381/312

(57) ABSTRACT

The present invention relates to a hearing protection method while reproducing an audio file, includes: selecting at least one of the audio files as predetermined audio files; receiving a play instruction; resetting a playing time when receiving the play instruction; obtaining and reproducing a desired audio file in accordance with the play instruction; clocking the playing time; detecting whether the playing time surpasses a predetermined critical duration; and when the playing time surpasses the predetermined critical duration, terminating the reproducing of the desired audio file; obtaining and reproducing the at least one predetermined audio files, thus, preventing users from hearing damage. The present invention also provides a corresponding audio processing system for hearing protection.

### BACKGROUND OF THE INVENTION

1. Field of the Invention

The present invention relates to a system and method for maintaining health of users while listening to music, especially to an audio processing system and method for hearing protection while listening to music.

2. Description of Related Art

Developments in the digital technology has made portable audio devices (such as MP3 player) become popular. When environmental noise external to the portable audio device is loud or when a favorite audio file is played, a user commonly increases the volume of a portable device. However different users have different physiological hearing threshold, i.e., loudness discomfort level (LDL). If a user is exposed to an environment with a noise volume level that is larger than the user's LDL for a long time, the user's hearing may be impaired. Furthermore medical studies have shown that listening to music with headphones for over 90 minutes a day causes long term hearing impairment.

In order to solve the above mentioned problems, there is a common gain control system and method available in the market. The gain control system and method provide a gain value limit, and prevents the user to adjust the gain value beyond the gain value limit. The system and method are preprogrammed and restricts the user choices and is not user friendly.

Therefore, a heretofore unaddressed need exists in the industry to overcome the aforementioned deficiencies and inadequacies.

### SUMMARY OF THE INVENTION

The present invention provides an audio processing system and method for hearing protection. The audio processing system clocks a playing time while reproducing desired audio file, if the playing time surpasses a predetermined critical duration, the audio processing system terminates the playing of the desired audio file, and reproduces a predetermined audio file with slow beat.

The audio processing system includes a storage unit, a command input unit, and a central processing unit. The storage unit is configured for storing a plurality of audio files, and at least one of audio files is selected as predetermined audio files. The command input unit is configured for receiving an operational input of a user, and generating a play instruction corresponding to the operational input. The central processing unit includes a monitor module, a playing module, a detecting module and a controlling module. The monitor module resets a playing time and clocks the playing time. The playing module fetches and reproduces the audio files stored in the storage unit. The detecting module receives the play instruction, signals the monitor module to reset the playing time, signals the playing module to fetch and reproduce a desired audio file stored in the storage unit, and signals the monitor module to clock the playing time. The controlling module detects whether the playing time surpasses a predetermined critical duration. If the playing time surpasses the predetermined critical duration, the controlling module signals the playing module to terminate the reproducing of the desired audio file, obtains the at least one predetermined audio files from the storage unit, and reproduces the at least one predetermined audio files.

Other systems, methods, features, and advantages will be or become apparent to one with ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a schematic diagram of an audio processing system for hearing protection in accordance with a first preferred embodiment of the present invention.

FIG. 2 is a schematic setting menu of a hearing protection function in accordance with the first preferred embodiment of the present invention.

FIG. 3 is a schematic setting menu of the hearing protection function in accordance with a second preferred embodiment of the present invention.

FIG. 4 is a schematic diagram of main function modules of a central processing unit of FIG. 1.

FIGS. 5 and 6 are a flowchart of a preferred method for hearing protection by utilizing the audio processing system of FIG. 1.

### DETAILED DESCRIPTION OF THE INVENTION

In the following embodiments, a hearing protection function incorporated in an audio processing system, such as a portable audio player, is depicted. The audio processing system of the present invention prevents a user from hearing damage while the user is listening to audio file. The following detailed description of the embodiments is made with reference to the attached drawings.

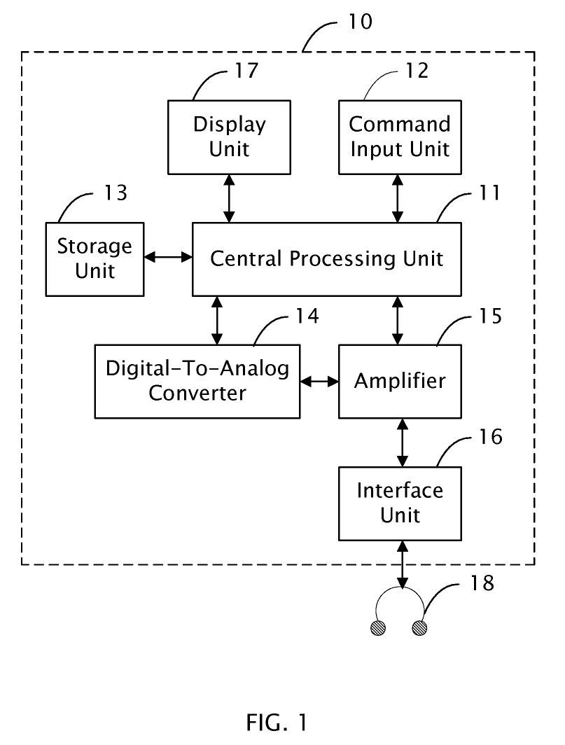

FIG. 1 is a schematic diagram of a hardware infrastructure of an audio processing system in accordance with a first preferred embodiment of the present invention. The audio processing system 10 includes a central processing unit 11, a command input unit 12, a storage unit 13, a digital-to-analog converter 14, an amplifier 15, an interface unit 16, and a display unit 17.

When the audio processing system 10 receives an operational input, the command input unit 12 generates a command signal corresponding to the operational input, such as a play instruction. The storage unit 13 stores a plurality of audio files and an audio processing program. At least one of the audio files, whose beat is considered by the user as slow, is selected as predetermined audio files. The display unit 17 provides a display panel. The display panel is configured for displaying a setting menu of a hearing protection function and parameters of the audio file. The parameters of the audio file include a name, a singer, a playing time, and so on.

After receiving an operational input of playing a desired audio file, the command input unit 12 generates the play instruction, and sends the play instruction to the central processing unit 11. The central processing unit 11 receives the play instruction, obtains the audio processing program and the desired audio file, and signals the audio processing program to decode the desired audio file to digital audio signals.

The digital-to-analog converter 14 converts the digital audio signals to analog audio signals. The amplifier 15 amplifies the analog audio signals, and transmits the analog audio signals to a sound output device 18 via the interface unit 16. The sound output device 18 outputs sounds corresponding to the analog audio signals. The sound output device 18 may be an earphone or a speaker.

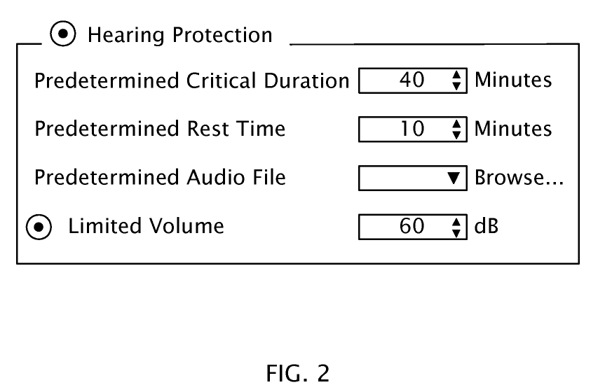

FIG. 2 is a schematic setting menu of the hearing protection function in accordance with a first preferred embodiment of the present invention. Referring to FIG. 2, the user can select the hearing protection function through the setting menu of the hearing protection function. After the hearing protection function is selected, the user may further adjust parameters of the hearing protection function, such as a predetermined critical duration, a predetermined rest time, a predetermined audio file. The predetermined critical duration presents a duration that the user enjoys the audio file, such as 40 minutes. The predetermined rest time presents a duration that the user enjoys the predetermined audio file, such as 10 minutes. The predetermined audio file is selected because beat of the predetermined audio file is considered as slow. The predetermined audio file is such one of the audio files that may be reproduced repeatedly during the predetermined rest time.

After the hearing protection function is selected, the user may also select a limited volume function. After the limited volume function is selected, the user can adjust a predetermined volume. The predetermined volume is such an audio energy value that is suitable for the user enjoying music, such as 60 dB.

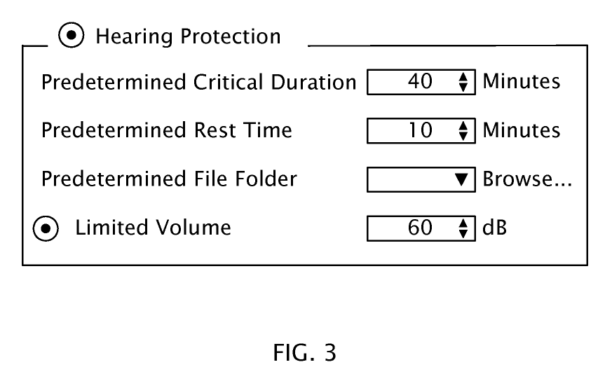

FIG. 3 is a schematic setting menu of the hearing protection function in accordance with a second preferred embodiment of the present invention. The setting menu of the hearing protection function of the second preferred embodiment has the same content as that of the first preferred embodiment, except a predetermined file folder instead of the predetermined audio file on the setting menu. The predetermined file folder includes a plurality of audio files whose beat is considered as slow by the user. The audio files of the predetermined file folder may be reproduced orderly or randomly during the predetermined rest time.

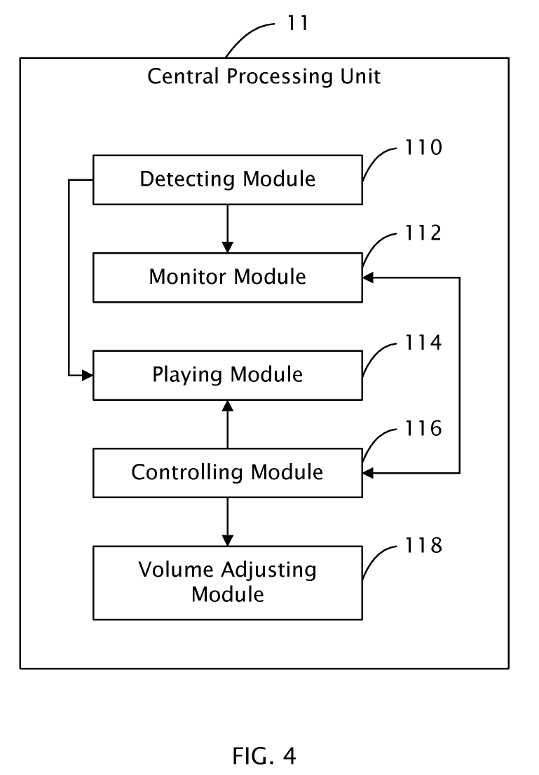

Referring to FIG. 4, the central processing unit 11 includes a detecting module 110, a monitor module 112, a playing module 114, a controlling module 116, and a volume adjusting module 118. The detecting module 110 receives the play instruction, and detects whether the hearing protection function is selected. If the hearing protection function is selected, the detecting module 110 signals the monitor module 112 to reset a playing time, signals the playing module 114 to fetch and reproduce the desired audio file, and signals the monitor module 112 to clock the playing time.

The controlling module 116 further detects whether the playing time surpasses a predetermined critical duration. If the controlling module 116 detects that the playing time surpasses the predetermined critical duration, the controlling module 116 signals the monitor module 112 to reset a rest time, records an operation state to the storage unit 13. The controlling module 116 also signals the playing module 114 to terminate the playing of the desired audio file. The operation state includes a name of the desired audio file and a current volume.

The controlling module 116 further detects whether the limited volume function is selected. When the controlling module 116 detects that the limited volume function is selected, the controlling module 116 signals the volume adjusting module 118 to adjust a current volume to the predetermined volume, and control the amplifier 15 to amplify the digital audio signals by the predetermined volume. The controlling module 116 further signals the playing module 114 to fetch one of the predetermined audio file, reproduce the predetermined audio file and signals the monitor module 112 to clock the rest time.

Furthermore, the controlling module 116 detects whether the rest time surpasses the predetermined rest time. If the controlling module 116 detects that the rest time surpasses the predetermined rest time, the controlling module 116 enables the operation state that is record in the storage unit 13, and signals the playing module 114 to reproduce the desired audio file continually.

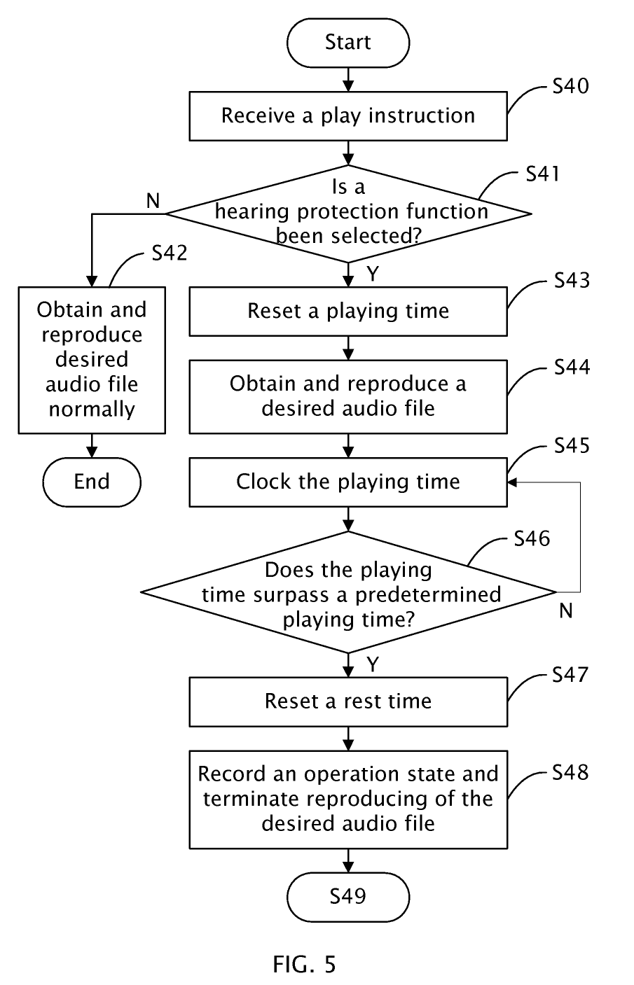

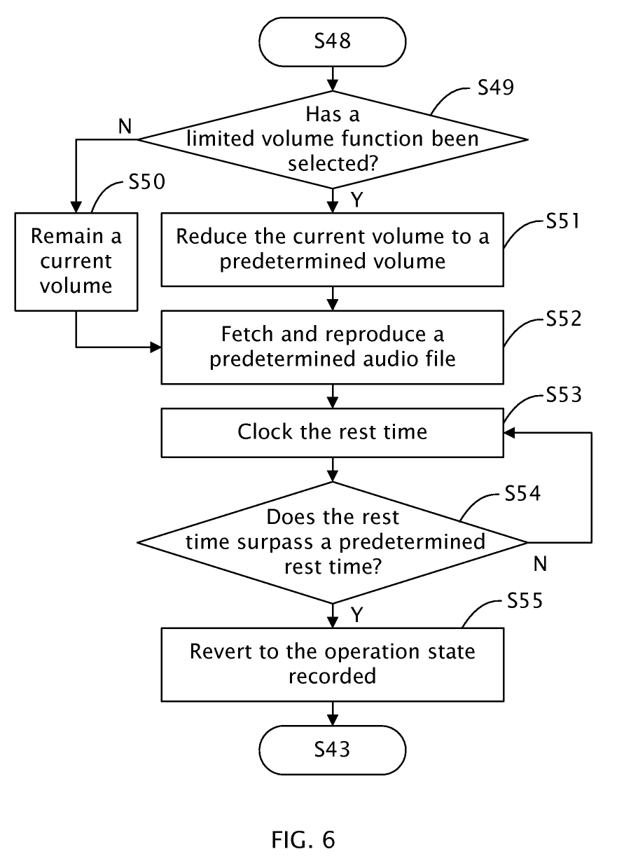

FIGS. 5 and 6 are a flowchart of a preferred method for hearing protection by utilizing the audio processing system of FIG. 1.

In step S40, the central processing unit 11 receives the play instruction from the command input unit 12.

In step S41, the central processing unit 11 detects whether the hearing protection function is selected.

If the hearing protection function is not selected, in step S42, the central processing unit 11 obtains the audio processing program and desired audio file, and performs the audio processing program to reproduce the desired audio file normally.

If the hearing protection function is selected, in step S43, the central processing unit 11 resets the playing time.

In step S44, the central processing unit 11 obtains the audio processing program and a desired audio file, and performs the audio processing program to reproduce the desired audio file.

In step S45, the central processing unit 11 clocks the playing time.

In step S46, the central processing unit 11 detects whether the playing time surpasses the predetermined critical duration. If the playing time does not surpass the predetermined critical duration, the procedure goes to step S45 to clock the playing time continually.

If the central processing unit 11 detects that the playing time surpasses the predetermined critical duration, in step S47, the central processing unit 11 resets the rest time.

In step S48, the central processing unit 11 records the operation state to the storage unit 13, and terminates the reproducing of the desired audio file.

In step S49, the central processing unit 11 detects whether the limited volume function is selected.

If the limited volume function is not selected, in step S50, the central processing unit 11 remains a current volume, and the procedure goes to step S52.

If the limited volume function is selected, in step S51, the central processing unit 11 adjusts the current volume to the predetermined volume, and controls the amplifier 15 to amplify the digital audio signals by the predetermined volume.

In step S52, the central processing unit 11 obtains the predetermined audio file from the storage unit 13, and reproduces the predetermined audio file.

In step S53, the central processing unit 11 clocks the rest time.

In step S54, the central processing unit 11 detects whether the rest time surpasses the predetermined rest time. If the rest time does not surpass the predetermined rest time, the procedure goes to step S53.

If the rest time surpasses the predetermined rest time, in step S55, the central processing unit 11 reverts to the operation state which is recorded in the storage unit 13, and the procedure goes to step S43.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An audio processing system for hearing protection, comprising:
a storage unit configured for storing a plurality of audio files, wherein at least one of the audio files is selected as predetermined audio files;
a command input unit configured for receiving an operational input, and for generating a play instruction corresponding to the operational input; and
a central processing unit comprising:
a monitor module for resetting a playing time, and clocking the playing time;
a playing module for fetching and reproducing an audio file stored in the storage unit;
a detecting module for receiving the play instruction, signaling the monitor module to reset the playing time, signaling the playing module to fetch and reproduce a desired audio file stored in the storage unit, and signals the monitor module to clock the playing time; and
a controlling module for detecting whether the playing time surpasses a predetermined critical duration, if the playing time surpasses the predetermined critical duration, signaling the playing module to terminate the reproducing of the desired audio file, obtaining the at least one predetermined audio files from the storage unit, and reproducing the at least one predetermined audio files.

2. The audio processing system according to claim 1, wherein before the controlling module signals the playing module to terminate the reproducing of the desired audio file, the controlling module further signals the monitor module to reset a rest time, and records an operation state to the storage unit.

3. The audio processing system according to claim 2, wherein after the playing module reproduces the predetermined audio file, the controlling module further signals the monitor module to clock the rest time, detects whether the rest time surpasses a predetermined rest time, and reverts to the operation state after the rest time surpasses the predetermined rest time.

4. The audio processing system according to claim 1, wherein the central processing unit further comprises a volume adjusting module; and before the controlling module signals the playing module to obtain the predetermined audio file, the controlling module detects whether a limited volume function is selected; if the limited volume function is selected, the controlling module signals the volume adjusting module to adjust a current volume to a predetermined volume.

5. The audio processing system according to claim 1, wherein the at least one predetermined audio files belong to a predetermined file folder.

6. A hearing protection method while reproducing an audio file, the method comprising:
selecting at least one of the audio files as predetermined audio files;
receiving a play instruction;
resetting a playing time when receiving the play instruction;
obtaining and reproducing a desired audio file in accordance with the play instruction;
clocking the playing time;
detecting whether the playing time surpasses a predetermined critical duration; and
if the playing time surpasses the predetermined critical duration, terminating the reproducing of the desired audio file;
obtaining and reproducing the at least one predetermined audio files.

7. The hearing protection method according to claim 6, before terminating the reproducing of the desired audio file, further resetting a rest time, and recording an operation state.

8. The hearing protection method according to claim 7, after the playing module reproducing the at least one predetermined audio files, further clocking the rest time, detecting whether the rest time surpassing a predetermined rest time, and reverting to the operation state if the rest time surpasses the predetermined rest time.

9. The hearing protection method according to claim 6, before obtaining the at least one predetermined audio files, further detecting whether a limited volume function is selected, adjusting a current volume to a predetermined volume if the limited volume function is selected.

10. The hearing protection method according to claim 6, wherein the at least one predetermined audio files are in a predetermined file folder.
